(19) United States
(12) Patent Application Publication
(10) Pub. No.: US 2022/0089093 A1
(43) Pub. Date: Mar. 24, 2022

(54) MASK CADDY

(71) Applicants: Jesse CHOQUETTE, Newmarket (CA); Jeinette TWEEDY, Newmarket (CA)

(72) Inventors: Jesse CHOQUETTE, Newmarket (CA); Jeinette TWEEDY, Newmarket (CA)

(21) Appl. No.: 17/025,216

(22) Filed: Sep. 18, 2020

(51) Int. Cl. B60R 7/05; A62B 9/04

(52) U.S. Cl. CPC B60R 7/05; B60R 2011/0035; A62B 9/04

(57) ABSTRACT

The present invention relates to a mask caddy that functions are to hold a mask keep it sanitary in your vehicle. This is achieved by the use of a flexible container or pouch that flexes open to expose an internal cavity or compartment. The container or pouch has attachment members adapted to engage with the vehicle's sun visor. The container or pouch also has a means of fastening to retain the mask in place within the internal cavity or compartment.

### FIELD OF THE INVENTION

The present disclosure relates to a mask caddy, particularly to a mask caddy adapted to fix to an interior surface of a vehicle, more particularly to a mask caddy adapted to fix to a sun visor.

### BACKGROUND

There are numerous different organizers and holders that can be affixed to the sun visors in vehicles. They can be specifically adapted to hold various different items, from glasses to cosmetics, and documents to personal defense items.

U.S. Pat. No. 10,183,628 discloses a portable trifold organizer which is adapted for attachment to an automobile sun visor having a plurality of pockets, a plurality of compartments attached to the outer surface of the organizer, with elastic straps for securing items within the compartments, and two bifolds to facilitate the trifold design. The plurality of pockets and plurality of compartments have various dimensions to accommodate articles selected for storage, and the two bifolds may have spacer regions to enhance storage capacity of the organizer. The plurality of elastic straps within the compartments has various dimensions to secure a variety of items within the organizer.

U.S. Pat. No. 9,315,158 discloses a sun visor housing for glasses that is secured to the visor by a wire clip or other appropriate connection to the sun visor. A portion of the compartment folds away, to allow removal of glasses, from the portion of the container which is clipped or fixed to the visor. The movable portion of the container is held firmly in place in a closed position as well as in an open condition by a magnet or other secure connection device.

US20040164110 discloses an organizer attachment for vehicle sun visor. The organizer comprises at least one strap having at least one of male and female fasteners for releasably mating with a complementary fastener carried by the organizer panel, such that the organizer panel is readily removed from the sun visor for transport outside of the vehicle. A fastener wrap is looped around the at least one strap, and includes fastener means for engaging and securing the third organizer panel to the vehicle sun visor.

US20170166136 discloses a document storage system includes a vehicle that has a visor. A pouch is provided and the pouch may contain documents. The pouch is removably coupled to the visor and the pouch is substantially comprised of a translucent material. Thus, the documents are visible within the pouch. A pair of clips is provided and each of the clips is coupled to the pouch. Each of the clips engages the visor.

U.S. Pat. No. 5,332,138 discloses a tissue container for automobile visor. The container is mounted to the visor using elastic cords which stretch to accommodate the increased volume of the tissues or a larger box of tissues inserted in the container which has a greater volume than the volume inside the housing of the container. The holder has a housing which is attached to the visor using elastic cords.

U.S. Pat. No. 10,005,400 discloses a sun visor eye wear holder comprises a panel, a plurality of pockets, and a plurality of straps. The plurality of pockets attach to the panel. The plurality of straps attach to the panel. Each of the plurality of straps forms a loop that attaches the panel to a sun visor of a vehicle.

U.S. Pat. No. 10,640,049 discloses a document storage device for staging documents for presentation to a law enforcement officer includes a first panel and a plurality of second panels. A first coupler is coupled to a back of the first panel and is configured to selectively and removably couple the first panel to a surface of a vehicle, such as a visor and a window edge. The pouch is readily repositioned from the visor of the vehicle to an edge of the driver's window in event the driver is pulled over by the law enforcement officer.

U.S. Pat. No. 2,707,072 discloses an article holder for sun visors which may be conveniently and effectively employed for accommodating a variety of different articles in an easily accessible manner. The means for sustaining the entire attachment in position on the sun visor comprise a plurality of elastic straps or bands 38 which are secured at one end thereof between the sheet portion 14 and the flap 30 by the aforementioned stitching 32, while the other ends or free ends of the strap or hands 38 are provided with snap fasteners 40 which are separably connected to co-acting fasteners

U.S. Pat. No. 5,503,316 discloses an article holder for a sun visor for supporting a personal aerosol weapon to a sun visor. An elongated strap has its free ends releasably engaging one another and is secured to the sun visor. The strap has hook and eye fasteners disposed between the free ends for releasably securing a housing on the strap. The housing receives an aerosol container therein.

USD728218 illustrates a container for holding first aid items. The container appears to be a rigid plastic box that has two slots that enable it to be slid onto a sun visor.

None of the above cited documents, alone or in combination satisfy the need for a mask caddy that specifically functions to hold a face mask and keep it sanitary within a vehicle. There therefore remains a need for a mask caddy that can satisfy this requirement.

All documents cited are incorporated herein in their entirety

### BRIEF SUMMARY

It is an object of the invention to provide a mask caddy.

In accordance with an aspect of the invention there is provided mask caddy, for attachment to a vehicle sun visor, said caddy comprising: a rectangular pouch, said pouch having two opposing lengths and two opposing widths; an opening along one of said two opposing lengths; and a means of attaching said pouch to said visor consisting of first and second attachment members, the first attachment member affixed to one of the opposing widths and the second attachment member affixed to another of the opposing widths.

In accordance with another aspect of the invention there is provided a mask caddy, for attachment to a vehicle sun visor, said caddy comprising: a body, formed from two opposing faces, said faces being bounded around their perimeter by sides, said sides of the opposing faces continuously joined together along approximately 75% of the perimeter of the sides; an interior cavity, having an opening formed between said two opposing faces, accessible through the perimeter of the sides that are not joined; a first attachment member affixed to a first section of said opposing joined faces of the body, said first attachment member being sized and proportioned to cooperate with said visor; and a second attachment member affixed to a second section of the opposing joined faces of the body, said second attachment member being sized and proportioned to cooperate with said visor, wherein the first and second attachment members affix said mask caddy to said sun visor.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a front side view of the subject matter in accordance with one embodiment of the invention.

FIG. 2 illustrates a front perspective view of the subject matter in accordance with one embodiment of the invention.

FIG. 3 illustrates a rear side view of the subject matter in accordance with one embodiment of the invention.

FIG. 4 illustrates a rear perspective view of the subject matter in accordance with one embodiment of the invention.

FIG. 5 illustrates a top perspective view of the subject matter in accordance with one embodiment of the invention.

FIG. 6 illustrates a side view of the subject matter in accordance with one installed embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The present invention describes a mask caddy that functions are to hold a mask keep it sanitary in your vehicle. This is achieved by the use of a flexible container or pouch that flexes open to expose an internal cavity or compartment. The container or pouch has attachment members adapted to engage with the vehicle's sun visor. The container or pouch also has a means of fastening to retain the mask in place within the internal cavity or compartment.

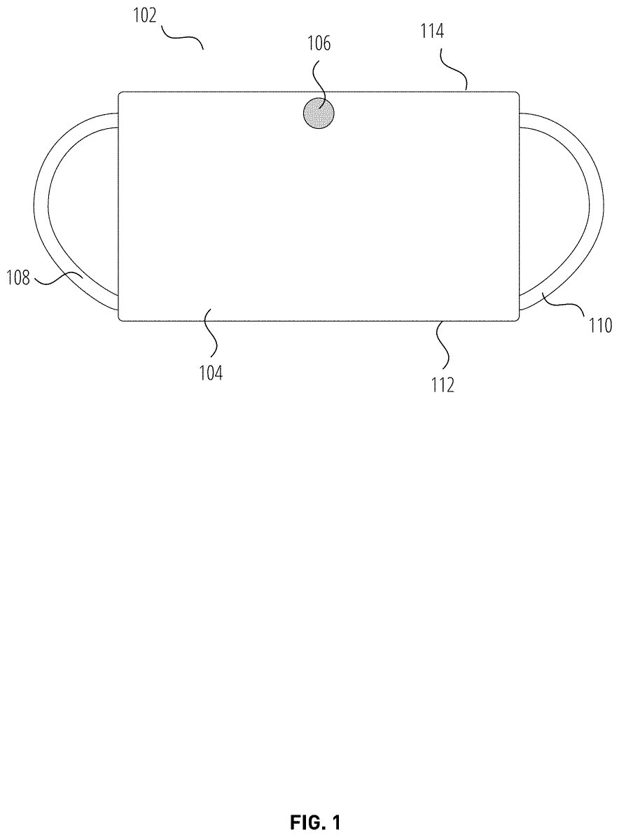

FIG. 1 illustrates a mask caddy 102 in accordance with one embodiment of the invention. The mask caddy 102 comprises a body 104 which is typically of a rectangular shape. At opposing ends of the body 104 are means of connecting the mask caddy 102 to the visor, The means of connecting, comprising a first attachment member 108 and a second attachment member 110. The mask caddy 102 may additionally comprises a fastener 106.

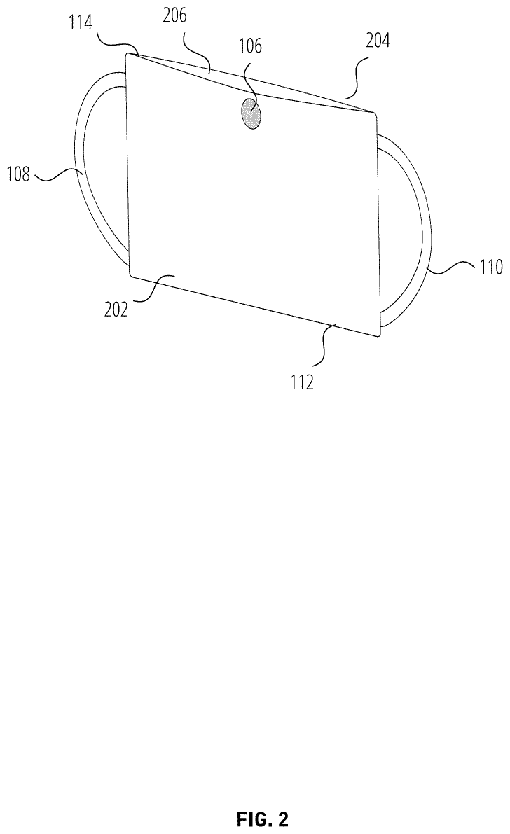

FIG. 2 illustrates a mask caddy 102 showing the front surface 202, the back surface 204. When the front surface 202 and back surface 204 flex apart along the upper edge 114, an internal compartment 206 can be accessed. A fastener 106 can be seen in this embodiment of the invention.

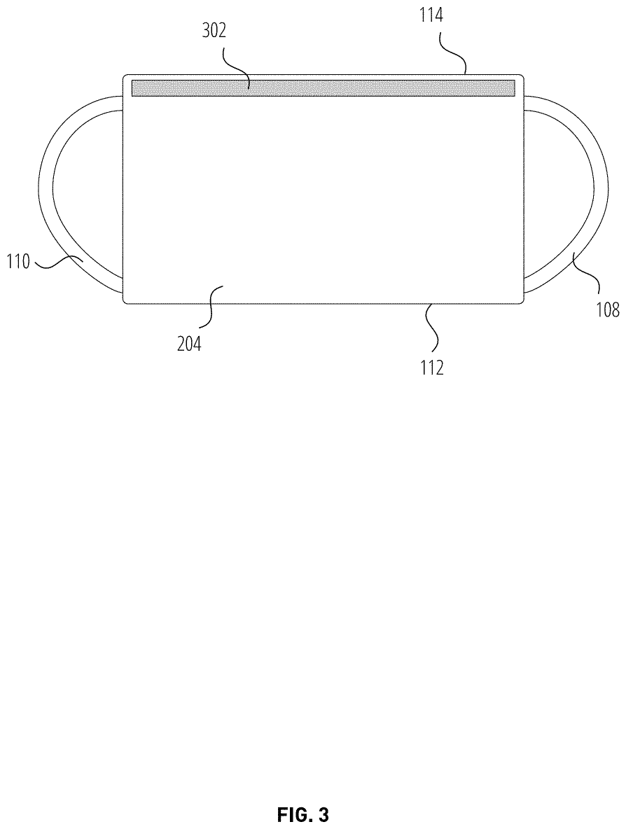

FIG. 3 illustrates a rear side of the mask caddy 102. An optional external strip 302 can be seen along the upper edge 114 of the back surface 204 of the body 104 of the mask caddy 102.

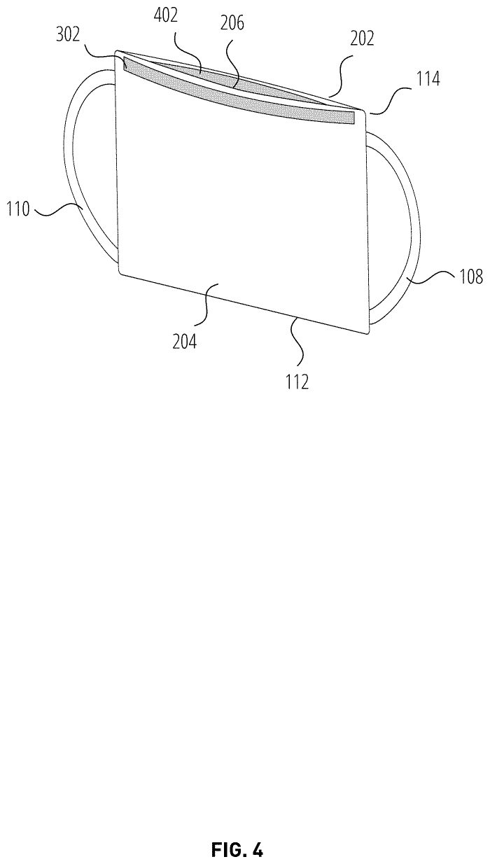

FIG. 4 illustrates a rear side of the mask caddy 102. An optional external strip 302 can be seen along the outside of the upper edge 114 of the back surface 204, and another optional internal strip 402 can be seen along the an inside of the upper edge 114 of the front surface 202 of the body 104 of the mask caddy 102.

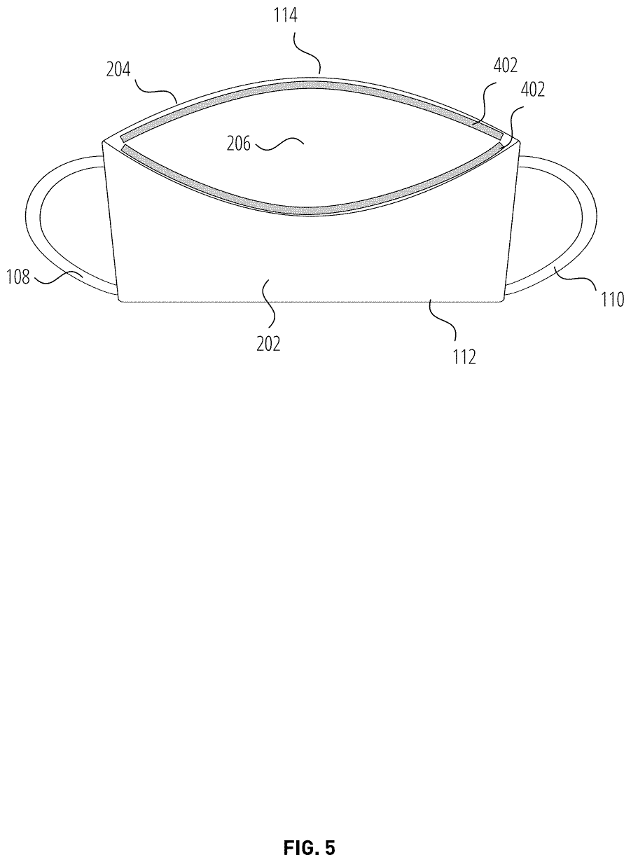

FIG. 5 illustrates a perspective view of a mask caddy 102. This view shows a fully open internal compartment 206 for receiving a mask. This embodiment of the invention comprises optional internal strips 402 on the inner surfaces of the upper edge 114 of the front surface 202 and the back surface 204.

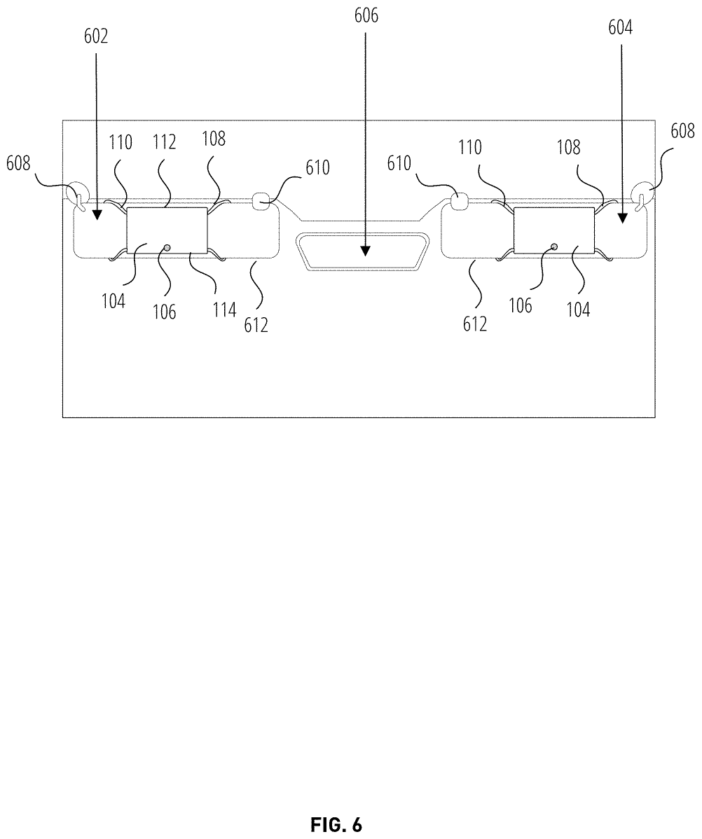

FIG. 6 illustrates two mask caddies 102 installed in a vehicle. One mask caddy 102 is installed on the driver sun visor 602 and the other on the passenger sun visor 604. The first attachment member 108 and second attachment member 110 are slid over one side of the visor and the body 104 of the mask caddy 102 over the other side of the visor. The upper edge 114 114 of the body 104 of the mask caddy 102, that define the internal compartment 206, is positioned on the outer edge 612 of the visor that is distanced apart from the edge of the visor that has the fixed hinge 608 and clip hinge 610.

With regard to the materials that the body 104 can be made of, it is contemplated that any flexible and washable material can be used. Typically including, but not limited to, silicone, foam, nylon, or fabric all of which provide durability and flexibility for holding the mask within the mask caddy 102.

The first attachment member 108 and second attachment member 110 are typically fabricated from an extensible material such, as but not limited to, elastic or rubber. They are sized and positioned in such a way that, in conjunction with a portion of the body 104 of the mask caddy 102, they will easily fit around the circumference of the visor, from the outer edge 612 of the visor to the edge of the visor having the fixed hinge 608 and the clip hinge 610. It is, however, contemplated that the first attachment member 108 and second attachment member 110 may be made from a non-extensible material. In this embodiment, the attachment members may be secured to the sun visor by way of fasteners attached to the members, such as but not limited to snap fasteners, magnets, and Velcro. In the alternative, the attachment members may be tied together in a knot or a bow.

In the figures as presented, the first attachment member 108 and second attachment member 110 are shown attached to the shorter edges of the rectangular body 104 of the mask caddy 102. It is, however, considered within the scope of the embodiments of the invention for the first attachment member 108 and second attachment member 110 to be attached to the longer edges of the rectangular body 104 of the mask caddy 102. Typically, the points of attachment would be positioned close to the shorter edges of the rectangular body 104 so as not to obstruct the opening of the internal compartment 206.

In an alternative embodiment, the first attachment member 108 and second attachment member 110 are in the form of a clip, sized and proportioned to be fixed onto the sun visor. The clips are typically affixed to outer opposing sides of the body 104, either side of the opening to the internal compartment 206.

Similarly, in the figures as presented, the body 104 of the mask caddy 102 is essentially rectangular. It is within the scope of the various embodiments of the invention as contemplated that the body 104 may be different shapes. For example, any and all quadrilateral shapes, including square, rhombus, or parallelogram. The body 104 may also be ovoid, or various novelty shapes, provided that they are appropriately sized and proportioned to accommodate a mask, and have fixing points for the first attachment member 108 and second attachment member 110.

In some embodiments of the invention, a fastener 106 may be included to secure the front surface 202 to the back surface 204 along the upper edges of the body 104 to prevent the mask from falling from the mask caddy 102. Numerous different types of fasteners are considered within the scope of the various embodiments of the invention. For example, opposing North and South magnets may be attached to the inner surfaces of the front surface 202 and back surface 204 of the body. Similarly, metal or plastic snap fasteners can be used in place of magnets. Patches or strips of Velcro can be affixed to the inner surfaces of abutting edges of the body, thereby serving a similar function as the magnets or snap fasteners.

In some embodiments, a rigid external strip 302 may be affixed along the outer edge or edges of the opening. Similarly, a rigid internal strip 402 may be affixed along the inner edge or edges of the opening. The external strip 302 and internal strip 402 may be fabricated from a hard-plastic material or a metallic strip. The function of the optional external strip 302 and/or internal strip 402 is to provide an increased level of rigidity to the otherwise flexible mask caddy 102. If and when present the one or more internal strips 402 or one or more external strips 302 will function to prevent the mask caddy 102 from unwanted sagging or flexing open. In the alternative, an external strip 302 may be fabricated from a material that has a relatively high coefficient of friction, thereby providing non-slip properties between the body 104 of the mask caddy 102 and the sun visor.

In use, it is contemplated that multiple mask caddies 102 can be affixed to the same sun visor, enabling multiple drivers and passengers to sort their mask within the vehicle. The mask caddies 102 can be sized such two will fit side by side on one surface if the sun visor. Alternatively, a mask caddy 102 can to fitted on one side of the visor, and another mask caddy 102 can be fitted to the other side of the sun visor.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A mask caddy, for attachment to a vehicle sun visor, said caddy comprising:
a rectangular pouch, said pouch having two opposing lengths and two opposing widths;
an opening along one of said two opposing lengths; and
a means of attaching said pouch to said visor consisting of first and second attachment members, the first attachment member affixed to one of the opposing widths and the second attachment member affixed to another of the opposing widths.

2. The mask caddy of claim 1, wherein said opening has a means of fastening the two opposing lengths together.

3. The mask caddy of claim 2, wherein said means of fastening the two opposing lengths together comprises magnets.

4. The mask caddy of claim 1, wherein said first and second attachment members are fabricated from elastic.

5. A mask caddy, for attachment to a vehicle sun visor, said caddy comprising:
a body, formed from two opposing faces, said faces being bounded around their perimeter by sides, said sides of the opposing faces continuously joined together along approximately 75% of the perimeter of the sides;
an interior cavity, having an opening formed between said two opposing faces, accessible through the perimeter of the sides that are not joined;
a first attachment member affixed to a first section of said opposing joined faces of the body, said first attachment member being sized and proportioned to cooperate with said visor; and
a second attachment member affixed to a second section of the opposing joined faces of the body, said second attachment member being sized and proportioned to cooperate with said visor,
wherein the first and second attachment members affix said mask caddy to said sun visor.

6. The mask caddy of claim 5, wherein the two opposing faces of the body are rectangular in shape with said perimeter having two opposing lengths and two opposing widths.

7. The mask caddy of claim 6, wherein the faces are joined along said perimeter along the two opposing widths and one of said two opposing lengths, to form said interior cavity.

8. The mask caddy of claim 5, wherein one or more fasteners are attached to opposing faces of said opening.

9. The mask caddy of claim 8, wherein the one or more fasteners are selected from the group consisting of: magnets; snap fasteners; and Velcro.

10. The mask caddy of claim 9, wherein the one or more fasteners are magnets.

11. The mask caddy of claim 6, wherein said first attachment member is affixed to one of said opposing widths and said second attachment member is affixed to another of said opposing widths.

12. The mask caddy of claim 5, wherein said first and second attachment members each have first and second ends.

13. The mask caddy of claim 12, wherein the first and second ends of the first attachment member is affixed to one of said opposing widths, the first and second ends of the second attachment member is affixed to another of said opposing widths.

14. The mask caddy of claim 6, wherein said first attachment member is affixed to one of said opposing lengths and said second attachment member is affixed to another of said opposing lengths.

15. The mask caddy of claim 11, wherein said first and second attachment members are clips.

16. The mask caddy of claim 11, wherein said first and second attachment members are fabricated from an extensible material

17. The mask caddy of claim 16, wherein said extensible material is selected from the group consisting of: elastic; or rubber.

18. The mask caddy of claim 17, wherein said extensible material is elastic.

19. The mask caddy of claim 5, wherein a non-slip member is attached to an outer face of said opening.

20. The mask caddy of claim 5, wherein a strengthening member is attached to one or more opposing faces of said opening.
